(19) United States
(12) Patent Application Publication
(10) Pub. No.: US 2025/0279816 A1
(43) Pub. Date: Sep. 4, 2025

(54) TIME DIVISION DUPLEX SEMI-ACTIVE BASE STATION ANTENNA SYSTEM

(71) Applicant: ONEUL E&M Co., Ltd., Seoul (KR)

(72) Inventors: Sang Gi KIM, Hwaseong-si (KR); Yury SINELNIKOV, Hwaseong-si (KR); Yo Han KIM, Hwaseong-si (KR); Sang Jin KIM, Hwaseong-si (KR); Do Sun NA, Hwaseong-si (KR); Do Hoon KIM, Yongin-si (KR)

(21) Appl. No.: 18/711,104

(22) PCT Filed: Nov. 8, 2023
(86) PCT No.: PCT/KR2023/017805

§ 371 Date: May 16, 2025

(30) Foreign Application Priority Data
Dec. 2, 2022 (KR) 10-2022-0166838

(51) Int. Cl. H04B 7/06; H04W 72/0446

(52) U.S. Cl. CPC H04B 7/0686; H04W 72/0446

(57) ABSTRACT

Provided is a time division duplex semi-active base station antenna system. The time division duplex semi-active base station antenna system includes: an antenna block including a plurality of transmission/reception-combined antenna elements; a TxRx switching block configured to separate a transmission path and a reception path, which are connected to the transmission/reception-combined antenna elements, from each other by a timing signal for time division control; and a TxRx timing recovery block configured to generate the timing signal from a transmission signal provided from a radio unit.

### TECHNICAL FIELD

The present invention relates to a time division duplex semi-active base station antenna system, and more particularly, to a time division duplex semi-active base station antenna system capable of replacing a multi-beam steering function with a simplified structure in a base station antenna system having a multiple-input multiple-output (MIMO) configuration.

### BACKGROUND ART

In general, a cellular base station may include at least one antenna, a radio unit, and a baseband unit. The radio unit, which is also referred to as a remote radio head (RRH), may include a transmitter path in which a power amplifier (PA) is provided, a receiver path in which a low noise amplifier (LNA) is provided, and an RF channel filter.

FIG. 1 is a view for describing an installation structure of a base station antenna, which is conventionally proposed. When an RF-frequency wireless signal of a cellular system is transmitted through a coaxial cable extending to an RRH as shown in (a) of FIG. 1, a significant amount of signal loss may occur. A 5G new radio (NR) mobile network cell operating at a C-band frequency may have greater losses in a capacity and overall throughput data due to losses of interconnected cables and an internal antenna feeder.

In order to solve a problem of a loss of a high-frequency cable connected between an RRH and an antenna, as shown in (b) of FIG. 1, a structure in which an RRH is connected directly under an antenna on a tower has been proposed. In addition, as shown in (c) of FIG. 1, Patent Document 1 has presented an antenna structure in which a wireless transceiver (Tx/Rx chain) is completely integrated with each of antenna array radiator units, and the wireless transceiver of an RRH is integrated with a patch antenna through a multi-layer PCB process.

Integrated antenna solutions of (b) and (c) of FIG. 1 were able to improve a data transmission speed, a data transmission capacity, and coverage expansion by reducing a loss of interconnected coaxial cables. However, since radio devices and antennas are allocated to a top of a base station tower, problems such as a lack of an installation space in a multi-antenna and increases in an installation cost and era maintenance difficulty due to high pricing of an integrated active antenna may be caused.

In particular, a massive multi-input multi-output (m-MIMO) antenna such as an antenna with 32TRX or 64TRX has attempted to improve a transmission capacity, a transmission speed, and delay performance by integrating a radio unit with an antenna, but the m-MIMO antenna has become a main reason for delaying nationwide network construction costs due to a high initial installation cost. In addition, even when an m-MIMO antenna equipped with an array antenna of 32TRX or 64TRX is used, vertical and horizontal beam steering has many deficiencies in implementing theoretical performance, thereby only highlighting disadvantages of the m-MIMO antenna.

### Documents of Related Art

(Patent Document 1) U.S. patent application US20180192508A1 “A Multi-Layer Printed Circuit Board and a Wireless Communication Node”

### DISCLOSURE

### Technical Problem

An object of the present invention is to provide a semi-active antenna structure in which, even when a device is on a ground, an RF loss of interconnected coaxial cables is settled, and uplink coverage and a processing capacity of a 5G NR network that is comparable with m-MIMO is improved, so that installation and operating costs for constructing a base station antenna network may be improved.

Another object of the present invention is to provide a base station antenna system in which, through precise sectoring such as four sectors or six sectors, an increase in a required transmission capacity is fulfilled, and wide service coverage is ensured, so that installation and operation costs for deploying a C-band 5G NR network may be reduced.

Objects of the present invention are not limited to the above-described objects, and other objects that are not described will be clearly understood by those skilled in the art from the following description.

### Technical Solution

To achieve the object described above, according to an embodiment of the present invention, there is provided a time division duplex integrated semi-active base station antenna system including: an antenna block including a plurality of transmission/reception-combined antenna elements; a TxRx switching block configured to separate a transmission path and a reception path, which are connected to the transmission/reception-combined antenna elements, from each other by a timing signal for time division control; and a TxRx timing recovery block configured to generate the timing signal from a transmission signal provided from a radio unit.

In some embodiments of the present invention, the TxRx switching block may first and include: second switches configured to selectively connect both ends of the transmission path and the reception path; and a low noise amplifier configured to amplify a reception signal in the reception path.

In some embodiments of the present invention, the timing signal may connect the first switch and the second switch to the transmission path at a first time, and the timing signal may connect the first switch and the second switch to the reception path and turn on the low noise amplifier at a second time other than the first time.

In some embodiments of the present invention, the TxRx switching block may be connected between an input/output end connected to the radio unit and the antenna block to form the transmission path and the reception path, which are separated from each other, according to the timing signal.

In some embodiments of the present invention, the time division duplex integrated semi-active base station antenna system may further include: a channel filter configured to separate channels of the transmission signal that is output from the TxRx switching block and a reception signal that is provided to the switching block from each other.

In some embodiments of the present invention, the TxRx switching block may be inserted into the antenna block and connected to each of the transmission/reception-combined antenna elements.

In some embodiments of the present invention, the channel filter may be inserted between the TxRx switching block and the transmission/reception-combined antenna elements.

In some embodiments of the present invention, the time division duplex integrated semi-active base station antenna system may further include: a coupler configured to separate the transmission signal and provide the transmission signal to the TxRx timing recovery block.

In some embodiments of the present invention, the TxRx timing recovery block may include a log amplifier and a detector.

In some embodiments of the present invention, the time division duplex integrated semi-active base station antenna a reflector on which the system may further include: transmission/reception-combined antenna elements are arranged in a row, and the reflector may include one and opposite ends that are bent at a predetermined angle toward the transmission/reception-combined antenna elements so that a horizontal beam width is adjusted to 45 degrees.

In some embodiments of the present invention, the transmission/reception-combined antenna elements may be arranged in parallel to each other to form first to third rows of antenna arrays, and the first, second, and third rows of the antenna arrays may be fed such that amplitudes of electric fields have weighting of 1:2:1, so that a horizontal beam width is adjusted to 33 degrees.

To achieve the object described above, according to another embodiment of the present invention, there is provided division duplex integrated semi-active base station antenna system including: an antenna block including a plurality of transmission/reception-combined antenna elements; and a TxRx switching block configured to separate a transmission path and a reception path, which are connected to the transmission/reception-combined antenna elements, from each other by a timing signal for time division control, wherein the switching block includes: first and second switches configured to selectively connect both ends of the transmission path and the reception path; and a low noise amplifier configured to amplify a reception signal in the reception path.

In some embodiments of the present invention, the time division duplex integrated semi-active base station antenna system may further include: a TxRx timing recovery block configured to generate the timing signal from a transmission signal provided from a radio unit.

Specific details of other embodiments are included in the detailed description and the drawings.

### Advantageous Effects

According to an embodiment of the present invention, a time division duplex semi-active base station antenna system may include a transmission/reception antenna element in which a transmission antenna and a reception antenna are the same, and a transmission path and a reception path may be separated from each other through a timing signal by timing recovery from a transmission signal without the need to receive the timing signal from an external unit. Accordingly, the time division duplex semi-active base station antenna system may be directly connected to a conventional RRH without the need to be integrally implemented with the conventional RRH, so that an excellent effect of reducing installation and maintenance costs can be achieved.

Effects of the present invention are not limited to the above-described effects, and other effects that are not described will be clearly understood by those skilled in the art from the description of the claims.

### DESCRIPTION OF DRAWINGS

FIG. 1 is a view for describing an installation structure of a base station antenna according to the related art.

FIG. 2 is a view for describing a time division duplex semi-active base station antenna system according to an embodiment of the present invention.

FIGS. 3a and 3b are views for describing a time division duplex semi-active base station antenna system according to another embodiment of the present invention.

FIG. 4 is a view for describing structures of an antenna array and a reflector, which are included in the time division duplex semi-active base station antenna system according to the embodiment of the present invention.

FIG. 5 is a view for describing an antenna array included in a time division duplex semi-active base station antenna system according to the embodiment of the present invention.

FIG. 6 is a view for describing a fine sectoring structure that may be applied to the semi-active base station antenna system according to the embodiment of the present invention.

FIG. 7 is a view for describing a beam pattern that may be obtained by the semi-active base station antenna system according to the embodiment of the present invention.

### BEST MODE

Advantages and features of the present invention and methods for accomplishing the same will be understood more readily with reference to the following detailed description of embodiments taken in conjunction with the accompanying drawings. However, the present invention may be embodied in various different forms without being limited to the embodiments disclosed below, the present embodiments are merely provided so that the disclosure of the present invention will be thorough and complete, and the scope of the invention will be fully conveyed to a person having ordinary skill in the art to which the present invention pertains, and the present invention will only be defined by the scope of the claims. Like reference numerals refer to like elements throughout the specification.

When one element is described as being “connected to” or “coupled to” another element, this configuration includes both a case in which the element is directly connected or coupled to the other element and a case in which another element is interposed between the elements. Meanwhile, when one element is described as being “directly connected to” or “directly coupled to” another element, this indicates that there is no intervening other element. The term “and/or” includes each of described items and all combinations of one or more of the described items.

The terms used herein are intended to describe embodiments, and shall by no means limit the present invention. In the present specification, an expression in a singular form includes a meaning 4 plural form unless specifically described otherwise in the statement. As used herein, the term “comprises” and/or “comprising” indicates that described components, steps, operations, and/or elements do not preclude the presence or addition of one or more other components, steps, operations, and/or elements.

Although the terms such as “first” and “second” are used to describe various elements, these elements are not limited by these terms. These terms are used only to distinguish one element from another element. Therefore, a first element described below may be a second element within the technical idea of the present invention.

Unless defined otherwise, all terms (including technical and scientific terms) used herein may have meanings that may be commonly understood by a person having ordinary skill in the art to which the present invention pertains. In addition, terms defined in generally used dictionaries shall not be interpreted to have an idealistic or excessive meaning unless explicitly and specifically defined otherwise.

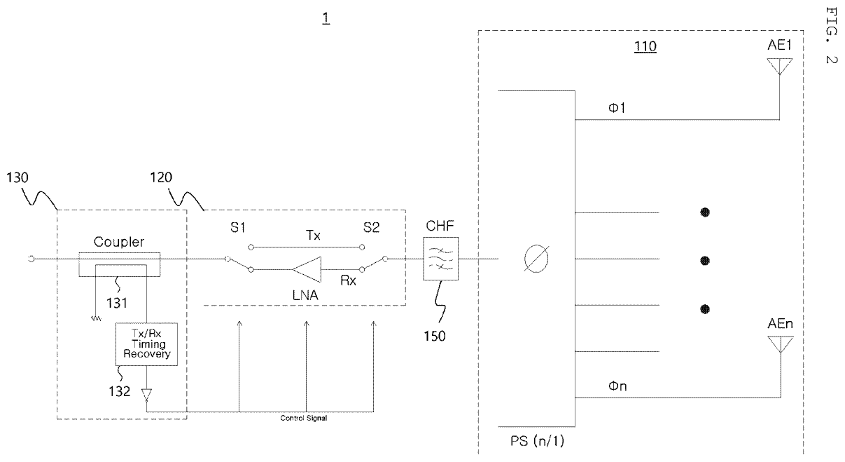

FIG. 2 is a view for describing a time division duplex semi-active base station antenna system according to an embodiment of the present invention.

Referring to FIG. 2, according to an embodiment of the present invention, a time division duplex semi-active base station antenna system may include: an antenna block 110 including a plurality of transmission/reception-combined antenna elements; a TxRx switching block 120 configured to separate a transmission path and a reception path, which are connected to the transmission/reception-combined antenna elements, from each other by a timing signal for time division control; and a TxRx timing recovery block 130 configured to generate the timing signal from a transmission signal provided from a radio unit.

The antenna block 110 may include a phase shifter PS (n/1) and a plurality of transmission/reception-combined antenna elements AE1 to AEn. The transmission/reception-combined antenna elements AE1 to AEn of the antenna block 110 may be arranged on a reflector to form a predetermined array. As the name suggests, the transmission/reception-combined antenna elements AE1 to AEn may be used for both transmission and reception, so that the same antenna element may be used for uplink and downlink.

The TxRx switching block 120 may be controlled by a timing signal provided by the TxRx timing recovery block 130 to separate the transmission path Tx and the reception path Rx from each other. Between a coupler 131 and a channel filter 150, the TxRx switching block 120 may connect a first switch S1 and a second switch S2 to the transmission path Tx in a case of downlink connection, and may connect the first switch S1 and the second switch S2 to the reception path Rx in a case of uplink connection.

When the TxRx switching block 120 connects a reception signal to the reception path Rx, a low noise amplifier LNA may be turned on to low-noise-amplify the reception signal. As shown in the drawing, the low noise amplifier LNA may be connected only to the reception path Rx without being connected to the transmission path Tx so as to amplify only the reception signal. Since the reception signal is amplified by the low noise amplifier LNA, a receivable signal level may be prevented from being decreased by a power loss caused by a high-frequency cable extending from the semi-active base station antenna system 1 to a ground.

Meanwhile, the separation of the transmission path Tx and the reception path Rx through the connection of the first switch S1 and the second switch S2 by the TxRx switching block 120 may be performed in a time division duplex scheme by the timing signal provided by the TxRx timing recovery block 130. The TxRx timing recovery block 130 may include a coupler 131 and a TxRx timing recovery 132, and may include, for example, a log amplifier and a detector, so that the semi-active base station antenna system 1 may generate the timing signal for controlling the TxRx switching block 120 from the provided transmission signal.

The timing signal may include a switch selection signal for controlling the first switch S1 and the second switch S2, and an amplifier control signal for controlling turn-on of the low noise amplifier LNA. As described above, when the TxRx switching block 120 connects the transmission path Tx by the timing signal, the low noise amplifier LNA may be turned off, and when the reception path Rx is connected, the low noise amplifier LNA may be turned on.

The channel filter 150 may be disposed between the TxRx timing recovery block 130 and the antenna block 110 to prevent signal radiation to adjacent channels upon the transmission, and to prevent saturation of the low noise amplifier LNA caused by spurious signals introduced from the adjacent channels upon the reception.

A downlink operation by the semi-active base station antenna system 1 in FIG. 2 may be performed as follows. The transmission signal that is input from the radio unit on the ground through a high-frequency feed cable may be partially separated from the coupler 131 and provided to the TxRx timing recovery 132. The TxRx timing recovery 132 may generate the timing signal for connecting the first and second switches S1 and S2 of the TxRx switching block 120 to the transmission path Tx by a combination of the log amplifier and the detector by using the transmission signal.

transmission signal that has passed through the transmission path Tx of the TxRx switching block 120 and the channel filter 150 may be input to the antenna block 110, and may pass through the phase changer PS (n/1) so as to be radiated through the transmission/reception-combined antenna elements AE1 to AEn. In this case, the transmission signals may be tilted in a direction indicated by internal remote electric tilt (iRET), and the tilt may be controlled, for example, according to the antenna interface standards group (AISG) v3.0 standard.

Meanwhile, an uplink operation by the semi-active base station antenna system 1 may be performed as follows. The reception signal received through the transmission/reception-combined antenna elements AE1 to AEn may pass through the phase shifter PS (n/1) and the channel filter 150 so as to be provided to the TxRx switching block 120. The TxRx switching block 120 may connect the reception path Rx at the remaining time other than a time in which the transmission path Tx is connected by the timing signal generated by the TxRx timing recovery block 130, so that the reception signal may pass through the reception path Rx so as to be low-noise-amplified, and may be provided to the radio unit on the ground.

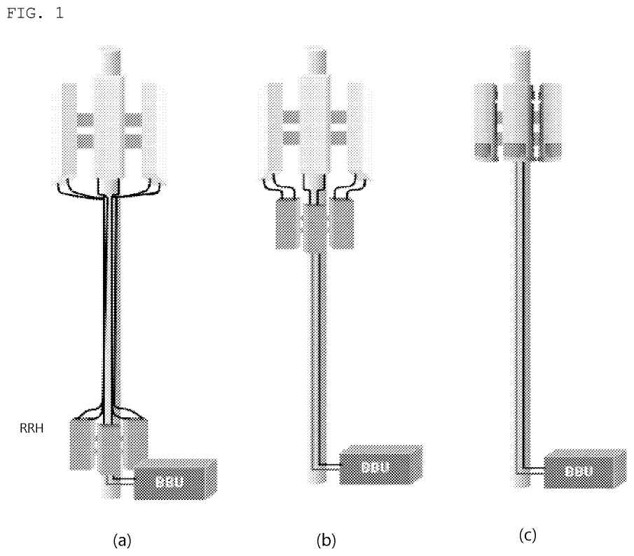

In summary, the semi-active base station antenna system 1 according to the embodiment of the present invention may include a transmission/reception antenna element in which a transmission antenna and a reception antenna are the same, and the transmission path and the reception path may be separated from each other through the timing signal by timing recovery from the transmission signal without the need to receive the timing signal from an external unit. Accordingly, the semi-active base station antenna system 1 may be directly connected to a conventional RRH as shown in (a) and (b) of FIG. 1.

In addition, when the reception path is connected by the generated timing signal, the reception signal may be amplified through the low-noise amplifier for amplifying the reception signal, so that reception sensitivity and uplink coverage may be improved. In other words, the base station antenna system according to the present invention may not need to be integrally implemented with the radio unit such as an RRH, so that an excellent effect of reducing installation and maintenance costs described above may be achieved.

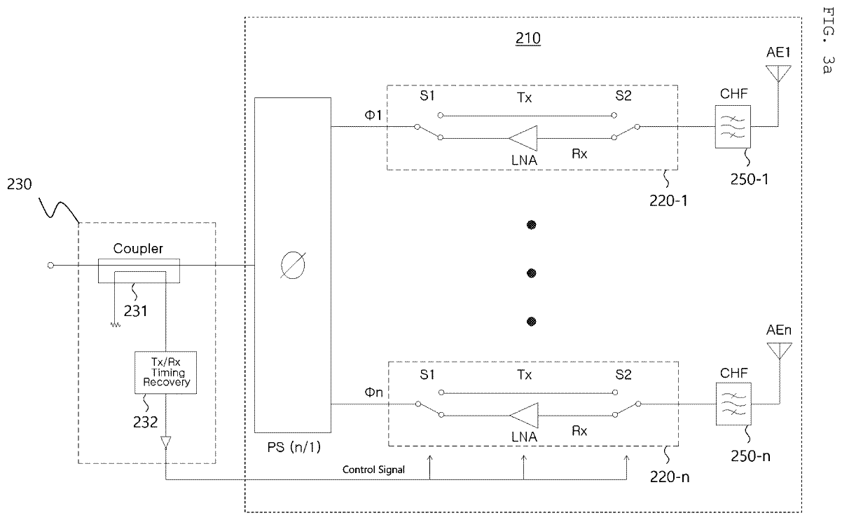

FIGS. 3a and 3b are views for describing a time division duplex semi-active base station antenna system according to another embodiment of the present invention.

Referring to FIG. 3a, according to another embodiment of the present invention, a time division duplex semi-active base station antenna system 2 1 may be different from the above embodiment of FIG. 2 in that TxRx switching blocks 220-1 to 220-n and channel filters 250-1 to 250-n are inserted into an antenna block 210. Regarding the above configuration, the description will focus on differences the embodiment described above, and descriptions of redundant elements will be omitted.

In detail, the TxRx switching blocks 220-1 to 220-n and the channel filters 250-1 to 250-n may correspond to a plurality of transmission/reception-combined antenna elements AE1 to AEn so as to be connected to the transmission/reception-combined antenna elements AE1 to AEn, respectively. In other words, the TxRx switching block 220-1 and the channel filter 250-1 may be connected to each transmission/reception-combined antenna element AE1.

Accordingly, a timing signal generated from a transmission signal and provided from a timing recovery block 230 may be provided to each of the TxRx switching blocks 220-1 to 220-n, so that a transmission path and a reception path may be separated from each other. However, the same timing signal may be provided to a plurality of TxRx switching blocks 220-1 to 220-n, so that, when one switching block is controlled by the timing signal to connect the transmission path, the remaining switching blocks may also connect the transmission paths.

A downlink operation of the semi-active base station antenna system 2 in FIG. 3 may be performed as follows. The transmission signal that is connected from a radio unit on a ground through a high-frequency feed cable may be partially separated from a coupler 231 and provided to a timing recovery 232. The timing recovery 232 may generate the timing signal for connecting first and second switches S1 and S2 of the TxRx switching blocks 220-1 to 220-n connected to the transmission/reception-combined antenna elements AE1 to AEn, respectively, to the transmission path Tx by a combination of a log amplifier and a detector by using the transmission signal. The transmission signal may be input to the antenna block 210, and may pass through a phase shifter PS (n/1). The transmission signal may be distributed to the transmission paths of the TxRx switching blocks 220-1 to 220-n according to tilt control of iRET, and may pass through the channel filters 250-1 to 250-n and the transmission/reception-combined antenna elements AE1 to AEn so as to be radiated to a free space.

Meanwhile, an uplink operation by the semi-active base station antenna system 2 may be performed as follows. The reception signal received through the transmission/reception-combined antenna elements AE1 to AEn may pass through the channel filters 250-1 to 250-n so as to be provided to the TxRx switching blocks 220-1 to 220-n. The TxRx switching blocks 220-1 to 220-n may connect the reception path Rx at the remaining time other than a time in which the transmission path Tx is connected by the timing signal generated by the timing recovery block 230, so that the reception signal may pass through the reception path Rx so as to be low-noise-amplified, and may pass through the phase shifter PS (n/1) and the coupler 231 so as to be provided to the radio unit on the ground.

According to the semi-active base station antenna system 2 of the embodiment of FIG. 3, the TxRx switching blocks 220-1 to 220-n may be connected to the transmission/reception-combined antenna elements AE1 to AEn, respectively, so that even a feeder loss inside the antenna that occurs during the distribution through the phase shifter PS (n/1) be may guaranteed. Accordingly, even an internal loss of an antenna that is not readily apparent, such as the feeder loss described above, as well as a power loss caused by the feed cable may be compensated for, so that an antenna gain may be optimized, and uplink performance may be improved.

Referring to FIG. 3b, in some other embodiments of the present invention, the channel filters 250-1 to 250-n may be connected to a rear end of the reception path Rx, that is, between the phase shifter PS (n/1) and the switching blocks 220-1 to 220-n. When TX and RX timing control between 5G NR service providers may be performed simultaneously, a problem of saturation of a reception low-noise amplifier caused by leakage electromagnetic waves adjacent from providers may be eliminated. In this case, the channel filters 250-1 to 250-n may be disposed on a rear side of a low noise amplifier LNA in the reception path Rx, so that a reception antenna gain may be improved as much as an insertion loss of the channel filters 250-1 to 250-n, and uplink reception sensitivity and coverage may be improved.

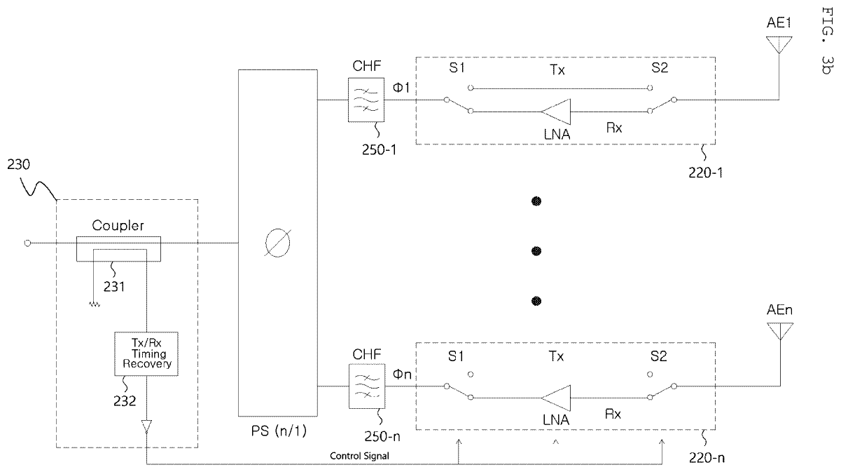

FIG. 4 is a view for describing structures of an antenna array and a reflector, which are included in the time division duplex semi-active base station antenna system according to the embodiment of the present invention.

Referring to FIG. 4, each of the antenna blocks 110 and 210 according to the embodiment of the present invention may include a reflector 300 configured to support the transmission/reception-combined antenna elements AE1 to AEn arranged in a row as shown in (b). The reflector 300 may include one and opposite ends 310 that are bent at a predetermined angle toward a plurality of transmission/reception-combined antenna elements AE. Through such a structure, a horizontal beam width of each of the antenna blocks 110 and 210 may be adjusted to 45 degrees, so that a horizontal beam steering function implemented by m-MIMO may be simplified and implemented. In addition, the arrangement may be performed to have an opening size that is greater than or equal to an opening size of a conventional 4T4R antenna or a conventional m-MIMO antenna in a vertical direction.

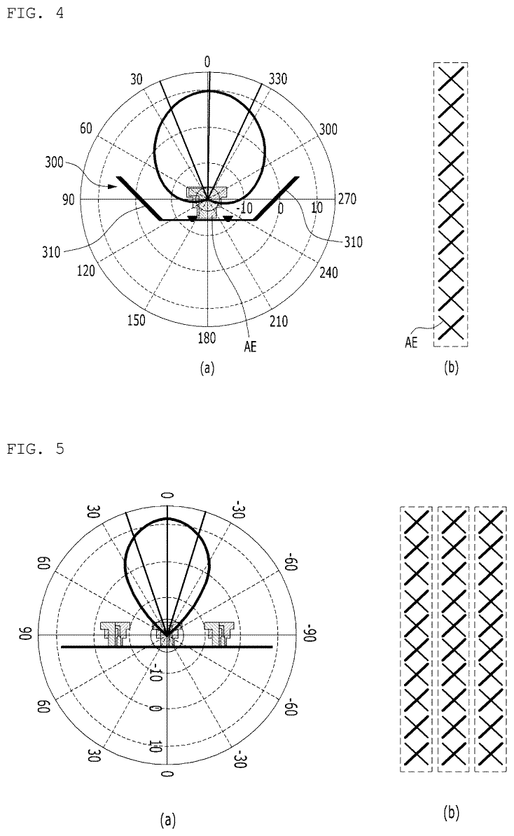

FIG. 5 is a view for describing an antenna array included in a time division duplex semi-active base station antenna system according to the embodiment of the present invention.

Referring to FIG. 5, three rows of dual polarization patch antennas may be arranged so as to be fed such that amplitudes of three dual polarization patch antenna electric fields have weighting of 1:2:1 according to the binomial distribution feeding theory, so that a horizontal beam width may be 33 degrees, and a minor lobe in a horizontal direction may be removed, so that interference with adjacent cells may be improved.

According to antenna arrangements and feeding structures of FIGS. 4 and 5, the semi-active base station antenna system according to the present invention may have a simplified horizontal/vertical beam steering function, and may have, in combination with the structures of FIGS. 2 and 3, uplink coverage performance that is comparable with existing 32TRX m-MIMO.

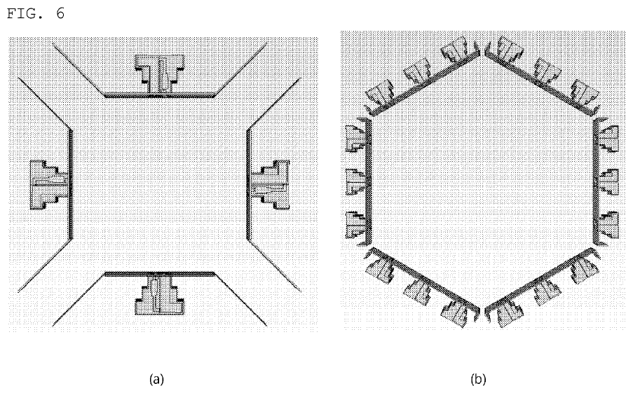

FIG. 6 is a view for describing a fine sectoring structure that may be applied to the semi-active base station antenna system according to the embodiment of the present invention.

Referring to FIG. 6, (a) of FIG. 6 shows a structure in which the reflector structure of FIG. 4 is applied to control the horizontal beam width to 45 degrees so that a 4-sector structure is applied, and (b) of FIG. 6 shows a structure in which the feed and arrangement structure of FIG. 5 is applied to control the horizontal beam width to 33 degrees. In a case of (b) of FIG. 6, interference with adjacent cells may be reduced due to the absence of a minor lobe, and a 6-sector structure may be applied as the energy efficiency of the system is improved, so that a transmission capacity of the system may be improved.

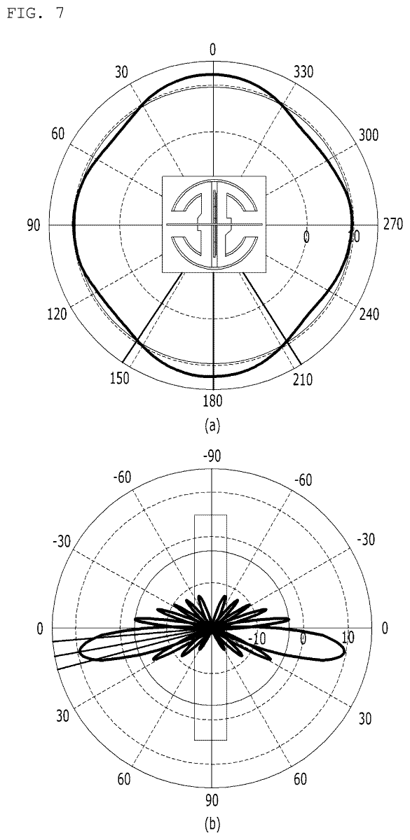

FIG. 7 is a view for describing a beam pattern that may be obtained by the semi-active base station antenna system according to the embodiment of the present invention.

Referring to FIG. 7, FIG. 7 is a view for describing that two dual polarization patch antennas may be arranged in opposite directions based on a reflector to perform in-phase feed, so that a pseudo-omnidirectional horizontal pattern ((a) of FIG. 7) with a horizontal beam width of approximately 360 degrees and a vertical pattern ((b) of FIG. 7) may be obtained, and the structures of FIGS. 6 and 7 may reduce, in combination with the semi-active antenna structures of FIGS. 2 and 3, an installation cost and an operating cost of a 5G NR network through various sector divisions.

Although the embodiments of the present invention have been described above with reference to the accompanying drawings, it will be understood by a person having ordinary skill in the art to which the present invention pertains that the present invention may be embodied in other specific forms without changing the technical idea or the essential features of the present invention. Therefore, the embodiments described above shall be understood as being illustrative but not restrictive in all respects.

### DESCRIPTION OF REFERENCE NUMERALS

1, 2: Semi-active base station antenna system 110, 210: Antenna block
120, 220: TxRx switching block 130, 230: TxRx timing recovery block
131, 231: Coupler 150, 250: Channel filter

1. A time division semi-active base station antenna system comprising:
an antenna block including a plurality of transmission/reception-combined antenna elements;
a TxRx switching block configured to separate a transmission path and a reception path, which are connected to the transmission/reception-combined antenna elements, from each other by a timing signal for time division control; and
a TxRx timing recovery block configured to generate the timing signal from a transmission signal provided from a radio unit.

2. The time division duplex semi-active base station antenna system of claim 1, wherein the TxRx switching block includes:
first and second switches configured to selectively connect opposite ends of the transmission path and the reception path; and
a low noise amplifier configured to amplify a reception signal in the reception path.

3. The time division duplex semi-active base station antenna system of claim 2, wherein the timing signal connects the first switch and the second switch to the transmission path at a first time, and
the timing signal connects the first switch and the second switch to the reception path and turns on the low noise amplifier at a second time other than the first time.

4. The time division duplex semi-active base station antenna system of claim 1, wherein the TxRx switching block is connected between an input/output end connected to the radio unit and the antenna block to form the transmission path and the reception path, which are separated from each other, depending upon the timing signal.

5. The time division duplex semi-active base station antenna system of claim 1, further comprising:
a channel filter configured to separate channels of the transmission signal that is output from the TxRx switching block and a reception signal that is provided to the TxRx switching block from each other.

6. The time division duplex semi-active base station antenna system of claim 5, wherein the TxRx switching block is inserted into the antenna block and connected to each of the transmission/reception-combined antenna elements.

7. The time division duplex semi-active base station antenna system of claim 6, wherein the channel filter is inserted between the TxRx switching block and the transmission/reception-combined antenna elements.

8. The time division duplex semi-active base station antenna system of claim 1, further comprising:
a coupler configured to separate the transmission signal and provide the transmission signal to the TxRx timing recovery block.

9. The time division duplex semi-active base station antenna system of claim 1, wherein the TxRx timing recovery block includes a log amplifier and a detector.

10. The time division duplex semi-active base station antenna system of claim 1, further comprising:
a reflector on which the transmission/reception-combined antenna elements are arranged in a row,
wherein the reflector includes one and opposite ends that are bent at a predetermined angle toward the transmission/reception-combined antenna elements so that a horizontal beam width is adjusted to 45 degrees.

11. The time division duplex semi-active base station antenna system of claim 1, wherein the transmission/reception-combined antenna elements are arranged in parallel to each other to form first to third rows of antenna arrays, and
the first, second, and third rows of the antenna arrays are fed such that amplitudes of electric fields have weighting of 1:2:1, so that a horizontal beam width is adjusted to 33 degrees.

12. A time division duplex semi-active base station antenna system comprising:
an antenna block including a plurality of transmission/reception-combined antenna elements; and
a TxRx switching block configured to separate a transmission path and a reception path, which are connected to the transmission/reception-combined antenna elements, from each other by a timing signal for time division control,
wherein the TxRx switching block includes:
first and second switches configured to selectively connect opposite ends of the transmission path and the reception path; and
a low noise amplifier configured to amplify a reception signal in the reception path.

13. The time division duplex semi-active base station antenna system of claim 12, further comprising:
a TxRx timing recovery block configured to generate the timing signal from a transmission signal provided from a radio unit.

14. The time division duplex semi-active base station antenna system of claim 13, wherein the timing signal connects the first switch and the second switch to the transmission path at a first time, and
the timing signal connects the first switch and the second switch to the reception path and turns on the low noise amplifier at a second time other than the first time.

15. The time division duplex semi-active base station antenna system of claim 12, wherein the TxRx switching block is connected between an input/output end connected to a radio unit and the antenna block to form the transmission path and the reception path, which are separated from each other, according to the timing signal.

16. The time division duplex semi-active base station antenna system of claim 12, further comprising:
a channel filter configured to separate channels of a transmission signal that is output from the TxRx switching block and the reception signal that is provided to the TxRx switching block from each other.

17. The time division duplex semi-active base station antenna system of claim 16, wherein the TxRx switching block is inserted into the antenna block and connected to each of the transmission/reception-combined antenna elements.

18. The time division duplex semi-active base station antenna system of claim 17, wherein the channel filter is inserted between the TxRx switching block and the transmission/reception-combined antenna elements.

19. The time division duplex semi-active base station antenna system of claim 12, wherein a channel filter is inserted between the TxRx switching block and the transmission/reception-combined antenna elements.

20. The time division duplex semi-active base station antenna system of claim 12, wherein the TxRx timing recovery block includes a log amplifier and a detector.

21. The time division duplex semi-active base station antenna system of claim 12, further comprising:
a reflector on which the transmission/reception-combined antenna elements are arranged in a row,
wherein the reflector includes one and opposite ends that are bent at a predetermined angle toward the transmission/reception-combined antenna elements so that a horizontal beam width is adjusted to 45 degrees.

22. The time division duplex semi-active base station antenna system of claim 12, wherein the transmission/reception-combined antenna elements are arranged in parallel to each other to form first to third rows of antenna arrays, and
the first, second, and third rows of the antenna arrays are fed such that amplitudes of electric fields have weighting of 1:2:1, so that a horizontal beam width is adjusted to 33 degrees.
